(19) United States
(12) Patent Application Publication
(10) Pub. No.: US 2024/0272300 A1
(43) Pub. Date: Aug. 15, 2024

(54) DISTANCE MEASURING APPARATUS AND DISTANCE MEASURING METHOD

(71) Applicant: SONY SEMICONDUCTOR SOLUTIONS CORPORATION, KANAGAWA (JP)

(72) Inventors: SHUJI UEHARA, KANAGAWA (JP); YOSHINORI MURAMATSU, KANAGAWA (JP); KAZUHIKO MURAOKA, KANAGAWA (JP)

(21) Appl. No.: 18/562,551

(22) PCT Filed: Jan. 18, 2022
(86) PCT No.: PCT/JP2022/001666

§ 371 Date: Nov. 20, 2023

(30) Foreign Application Priority Data
Jun. 10, 2021 (JP) 2021-097441

(51) Int. Cl. G01S 17/89; G01S 7/481; G01S 7/4914; G01S 17/66

(52) U.S. Cl. CPC G01S 17/89; G01S 7/4817; G01S 7/4914; G01S 17/66

(57) ABSTRACT

A distance measuring apparatus according to the present disclosure includes: an irradiation unit that emits irradiation light in a slit shape; a sensor unit that detects the irradiation light irradiated to a distance measuring target; an image processor that generates distance information pertaining to the distance measuring target based on a result of a detection by the sensor unit; and a controller that calculates a distance measuring target region in line with a size of the distance measuring target and sets an irradiation range of the irradiation light by the irradiation unit and a sensing range by the sensor unit to respective ranges in line with the target region.

### TECHNICAL FIELD

The present disclosure relates to a distance measuring apparatus and a distance measuring method.

### BACKGROUND ART

There is a distance measuring apparatus that emits irradiation light in a slit shape to a distance measuring target, causes a sensor to detect reflected light by the distance measuring target, and acquires distance information pertaining to the distance measuring target (see PTL 1).

### CITATION LIST

### Patent Literature

PTL 1: Japanese Unexamined Patent Application Publication No. 2006-333493

### SUMMARY OF THE INVENTION

In an ordinary distance measuring apparatus, irradiation light is emitted within a distance measuring region having a size determined beforehand. In there, a sensing range by a sensor is also determined beforehand. It is therefore difficult to control a distance measuring state to a desired state.

It is desirable to provide a distance measuring apparatus and a distance measuring method that make it possible to perform distance measurement in a desired distance measuring state.

A distance measuring apparatus according to an embodiment of the present disclosure includes: an irradiation unit that emits irradiation light in a slit shape; a sensor unit that detects the irradiation light irradiated to a distance measuring target; an image processor that generates distance information pertaining to the distance measuring target based on a result of a detection by the sensor unit; and a controller that calculates a distance measuring target region in line with a size of the distance measuring target and sets an irradiation range of the irradiation light by the irradiation unit and a sensing range by the sensor unit to respective ranges in line with the target region.

A distance measuring method according to an embodiment of the present disclosure includes: emitting irradiation light in a slit shape; detecting the irradiation light irradiated to a distance measuring target; generating distance information pertaining to the distance measuring target based on a result of a detection of the irradiation light; and calculating a distance measuring target region in line with a size of the distance measuring target and setting an irradiation range of the irradiation light and a sensing range of the irradiation light respectively to ranges in line with the target region.

In the distance measuring apparatus or the distance measuring method according to the embodiment of the present disclosure, a distance measuring target region in line with the size of the distance measuring target is calculated, and the irradiation range of the irradiation light and the sensing range of the irradiation light are set to respective ranges in line with the target region.

### BRIEF DESCRIPTION OF THE DRAWINGS

FIG. 1 is an explanatory diagram illustrating an outline of a distance measuring method to be performed by a distance measuring apparatus according to a first comparative example.

FIG. 2 is an explanatory diagram illustrating a principle of a distance measuring method using trigonometry.

FIG. 3 is an explanatory diagram illustrating an example of a pixel signal outputted from a sensor per one frame and a pixel signal of an inter-frame difference in the distance measuring method illustrated in FIG. 2.

FIG. 4 is an explanatory diagram illustrating an outline of a distance measuring method to be performed by a distance measuring apparatus according to a first embodiment of the present disclosure.

FIG. 5 is a block diagram schematically illustrating a configuration example of the distance measuring apparatus according to the first embodiment.

FIG. 6 is a flowchart illustrating an example of a control operation to be performed by the distance measuring apparatus according to the first embodiment.

FIG. 7 is an explanatory diagram illustrating a principle of a control operation in a case where a scan rate is to be increased in the distance measuring apparatus according to the first embodiment.

FIG. 8 is an explanatory diagram illustrating a principle of a control operation in a case where distance measuring accuracy is to be improved in the distance measuring apparatus according to the first embodiment.

FIG. 9 is an explanatory diagram illustrating a first example of a cutting-out range and scan directions for a distance measuring target region.

FIG. 10 is an explanatory diagram illustrating a second example of a cutting-out range and scan directions for a distance measuring target region.

FIG. 11 is an explanatory diagram illustrating an outline of a distance measuring method to be performed by a distance measuring apparatus according to a second comparative example.

FIG. 12 is an explanatory diagram illustrating an outline of a distance measuring method to be performed by a distance measuring apparatus according to a second embodiment.

FIG. 13 is a block diagram schematically illustrating a configuration example of the distance measuring apparatus according to the second embodiment.

FIG. 14 is a flowchart illustrating an example of a control operation to be performed by the distance measuring apparatus according to the second embodiment.

FIG. 15 is a block diagram schematically illustrating a configuration example of a distance measuring apparatus according to a modification example of the second embodiment.

FIG. 16 is an explanatory diagram illustrating an outline of a distance measuring method to be performed by a distance measuring apparatus according to a third comparative example.

FIG. 17 is an explanatory diagram illustrating a principle of a distance measuring method using trigonometry to be performed by a distance measuring apparatus according to a third embodiment.

FIG. 18 is an explanatory diagram illustrating an outline of the distance measuring method to be performed by the distance measuring apparatus according to the third embodiment.

FIG. 19 is a block diagram schematically illustrating a configuration example of the distance measuring apparatus according to the third embodiment.

FIG. 20 is an explanatory diagram schematically illustrating an example of pixel lines used to compute an inter-frame difference in a case where a distance measuring target is stationary.

FIG. 21 is an explanatory diagram schematically illustrating an example of pixel lines used to compute an inter-frame difference in a case where a distance measuring target is moving.

FIG. 22 is a flowchart illustrating an example of a control operation to be performed by the distance measuring apparatus according to the third embodiment.

FIG. 23 is a block diagram schematically illustrating a configuration example of a distance measuring apparatus according to a modification example of the third embodiment.

### MODES FOR CARRYING OUT THE INVENTION

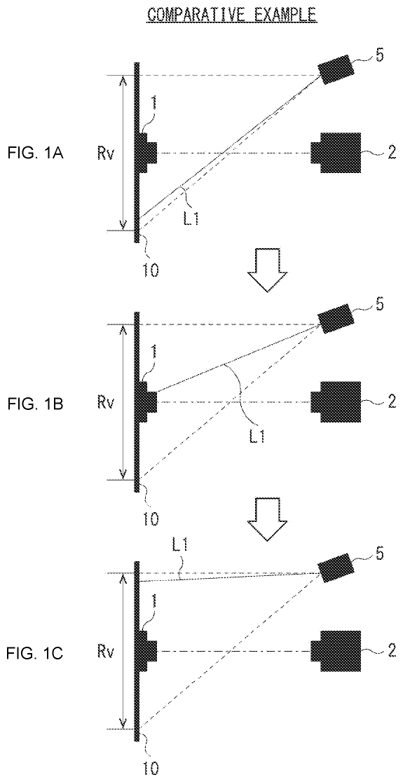

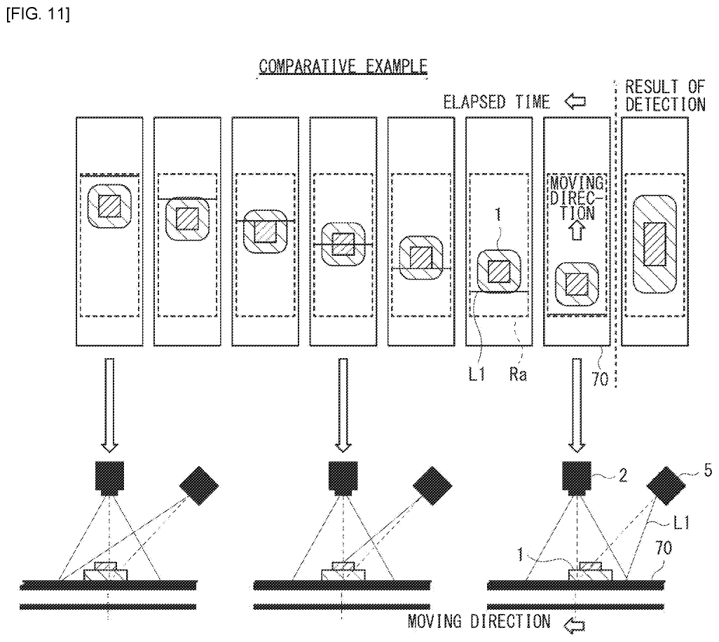

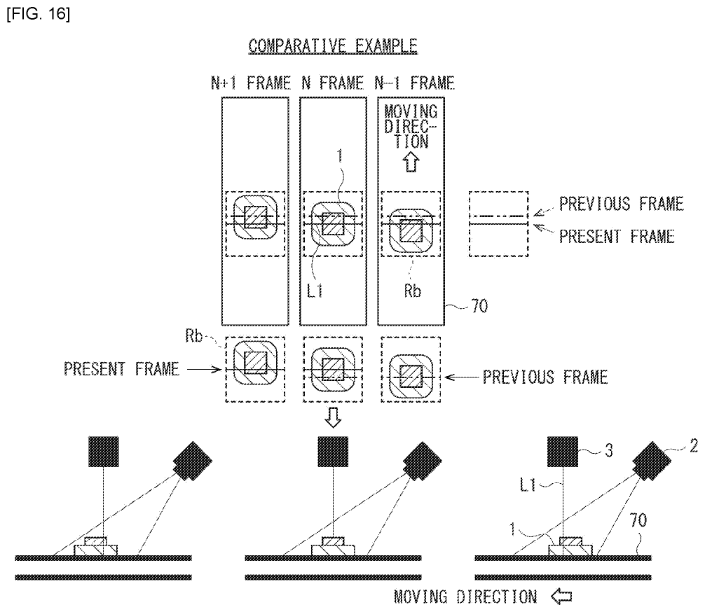

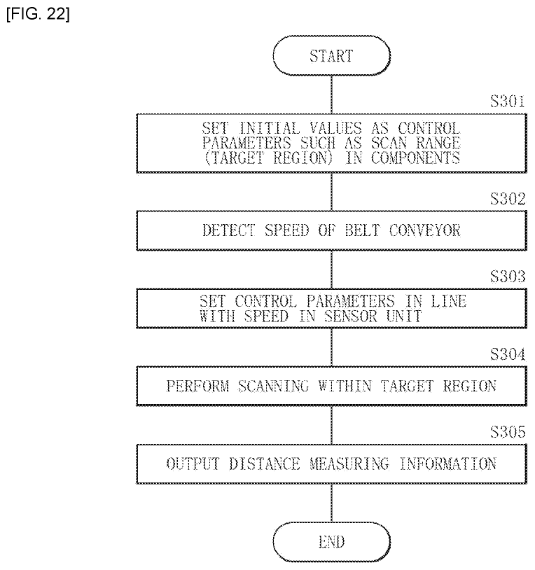

Embodiments of the present disclosure will now be described herein in detail with reference to the accompanying drawings. Note that the description is given in the following order.
1. First Embodiment (distance measuring apparatus having a plurality of distance measuring modes) (FIGS. 1 to 10)
1.0 Comparative Example
1.1 Configuration
1.2 Operation
1.3 Effects
2. Second Embodiment (distance measuring apparatus that tracks a distance measuring
target that is moving) (FIGS. 11 to 15)
2.0 Comparative Example
2.1 Configuration
2.2 Operation
2.3 Modification Example
2.4 Effects
3. Third Embodiment (distance measuring apparatus that computes an inter-frame difference in line with movement of a distance measuring target) (FIGS. 16 to 23)
3.0 Comparative Example
3.1 Configuration
3.2 Operation
3.3 Modification Example
3.4 Effects
4. Other Embodiments

### 1. First Embodiment

### 1.0 Comparative Example

FIG. 1 illustrates an outline of a distance measuring method to be performed by a distance measuring apparatus according to a first comparative example.

As the first comparative example, an example of the distance measuring apparatus applied with an optical cutting method is illustrated. The distance measuring apparatus according to the first comparative example includes an irradiation unit 5 that emits irradiation light L1 in a slit shape such as a laser beam and a sensor unit 2 that detects the irradiation light L1 emitted to a distance measuring target 1. The distance measuring target 1 is disposed on a reference surface 10.

The irradiation unit 5 includes, for example, a light source such as a laser light source that emits the irradiation light L1 such as a laser beam and a scan mirror such as a galvanometer mirror that changes a scan direction by the irradiation light L1. The irradiation unit 5 uses the scan mirror to emit the irradiation light L1 within a scan range Rv (an irradiation range) from a lower direction to an upper direction, as illustrated in (A), (B), and (C) in FIG. 1, for example, to scan a whole surface of the scan range Rv.

The sensor unit 2 includes a plurality of pixels. The sensor unit 2 performs sensing within the scan range Rv across a plurality of frames and detects the irradiation light L1 as reflected light from the distance measuring target 1. As a non-illustrated image processor performs signal processing on a detected signal by the sensor unit 2, distance information is generated.

In the distance measuring apparatus according to the first comparative example, the irradiation light L1 is emitted within the scan range Rv having a size determined beforehand. Furthermore, a sensing range by the sensor unit 2 is determined beforehand to be identical to the scan range Rv. It is therefore difficult to control a distance measuring state to a desired state.

In the distance measuring apparatus according to the first comparative example, distance measuring accuracy within the scan range Rv is constant, for example. To improve the distance measuring accuracy, it is necessary to increase scan frames in number in the sensor unit 2, and to decrease a scan rate by the irradiation unit 5. To increase the scan rate, it is necessary to decrease scan frames in number, and to lower the distance measuring accuracy.

### 1.1 Configuration

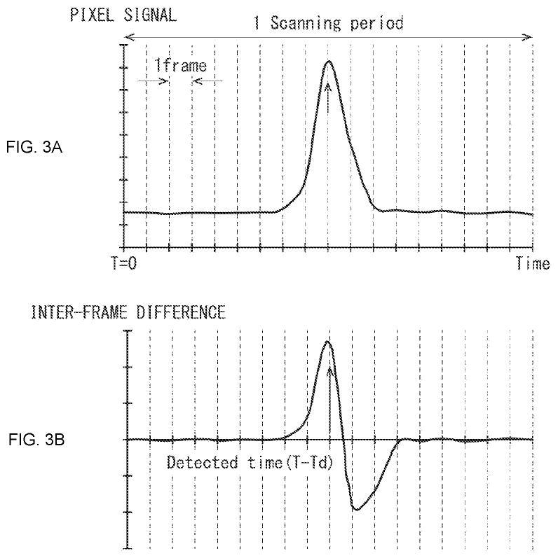

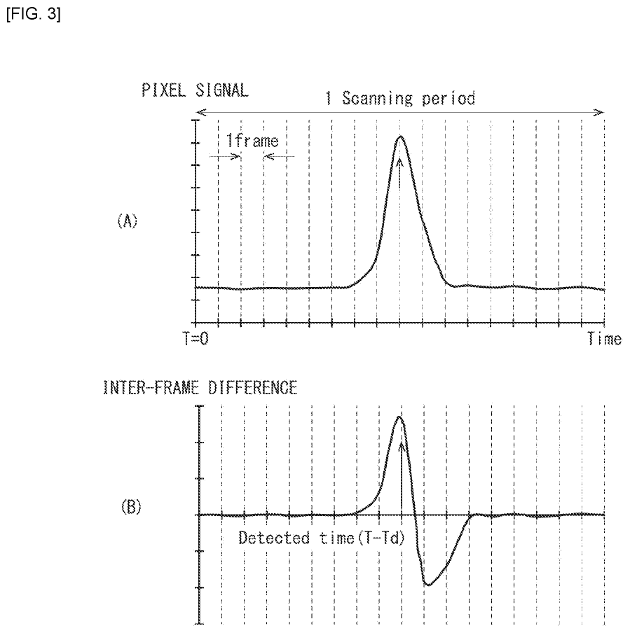

Before describing a configuration of a distance measuring apparatus 101 and a distance measuring method according to a first embodiment of the present disclosure, a principle of an ordinary distance measuring method using trigonometry will first be described with reference to FIG. 2. FIG. 3 illustrates an example of a pixel signal outputted from the sensor unit 2 per one frame ((A) in FIG. 3) and a pixel signal of an inter-frame difference ((B) in FIG. 3) in the distance measuring method illustrated in FIG. 2.

In the distance measuring method illustrated in FIG. 2, the irradiation unit 5 and the sensor unit 2 are used to perform distance measuring, similar to the distance measuring apparatus according to the first comparative example illustrated in FIG. 1. The irradiation unit 5 includes a light source 3 such as a laser light source that emits the irradiation light L1 such as a laser beam and a scan mirror 4 such as a galvanometer mirror that reflects the irradiation light L1 and changes the scan direction by the irradiation light L1. The sensor unit 2 includes a sensor (an imaging device) 21 and a light-receiving optical system 22. The sensor unit 2 uses the sensor 21 to detect, via the light-receiving optical system 22, reflected light from the distance measuring target 1 as the irradiation light L1. As a non-illustrated image processor performs signal processing on the detected signal by the sensor 21, distance information is generated.

In trigonometry, as illustrated in FIG. 2, the sensor unit 2 and the irradiation unit 5 are disposed to be away from each other with respect to the distance measuring target 1 that undergoes distance measurement. In such a disposition state as described above, the scan mirror 4 repeats such operation of causing the irradiation light L1 from the light source 3 to move in a predetermined direction (from the upper direction to the lower direction in the example illustrated in FIG. 2) to perform scanning.

While the irradiation light L1 is moving in the predetermined direction to perform scanning once, as illustrated in (A) in FIG. 3, frame sweeping is then performed several thousand times to several ten thousand times in the sensor 21. At a point in time of detecting reflected light by the distance measuring target 1 of the irradiation light L1, the pixels in the sensor 21 each output a pixel signal indicating the detection.

Note herein that, in a case where one of the pixels is focused on, a distance from the sensor 21 to the distance measuring target 1 and a swing angle of the scan mirror 4 at a point in time of detecting reflected light in a sight direction of the one of the pixels are uniquely determined. That is, by knowing a frame from which the irradiation light L1 is detected in a case where starting of scanning in the scan mirror 4 and starting of counting of frames in number in the sensor 21 are simultaneous to each other, the swing angle of the scan mirror 4 is determined. A distance value from the sensor 21 to the distance measuring target 1 is therefore determined.

By performing calibration beforehand for frames counted in number and a distance described above using a distance calibration object in an actual image sensor and causing a system side to store data pertaining to the frames counted in number and the distance in a table format, however, it is possible to perform highly-accurate absolute measurement of a distance.

In detecting reflected light by the distance measuring target 1 of the irradiation light L1, it is effective that reflected light of the irradiation light L1 is detected using an inter-frame difference used to remove influences of other ambient light than the irradiation light L1 ((B) in FIG. 3).

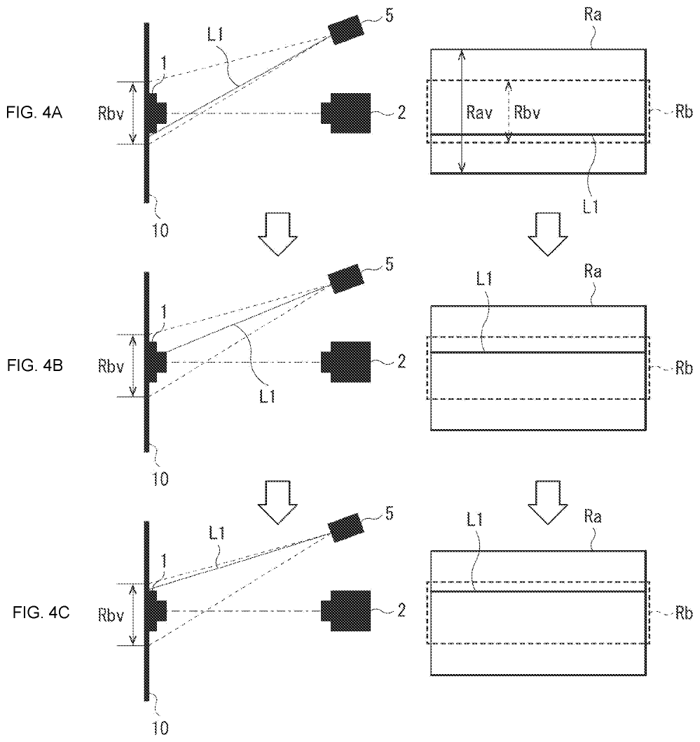

FIG. 4 illustrates an outline of the distance measuring method to be performed by the distance measuring apparatus 101 according to the first embodiment of the present disclosure.

In the distance measuring apparatus 101 according to the first embodiment, the sensor unit 2 performs sensing within a scan range across a plurality of frames and detects the irradiation light L1 as reflected light from the distance measuring target 1, similar to the distance measuring apparatus according to the first comparative example illustrated in FIG. 1. As a non-illustrated image processor performs signal processing on a detected signal by the sensor unit 2, distance information is generated.

Note herein that, in the distance measuring apparatus according to the first comparative example, the irradiation light L1 is emitted within the scan range Rv having a size determined beforehand. Furthermore, the sensing range by the sensor unit 2 is determined beforehand to be identical to the scan range Rv. In the distance measuring apparatus 101 according to the first embodiment, on the other hand, a distance measuring target region (Region of Interest (ROI)) Rb is to be calculated in line with a size of the distance measuring target 1. The irradiation range of the irradiation light L1 by the irradiation unit 5 and the sensing range by the sensor unit 2 are then set to respective ranges in line with the target region Rb. The target region Rb is at least set to a range where a scan range Rbv extending in vertical directions is narrower than a scan range Rav extending in the vertical directions in a normal scan range Ra. The irradiation unit 5 emits the irradiation light L1 to the target region Rb from the lower direction to the upper direction, as illustrated in (A), (B), and (C) in FIG. 4, for example, to scan the target region Rb. Note that the normal scan range Ra corresponds to a maximum irradiation range of the irradiation light L1 by the irradiation unit 5 and a maximum sensing range by the sensor unit 2.

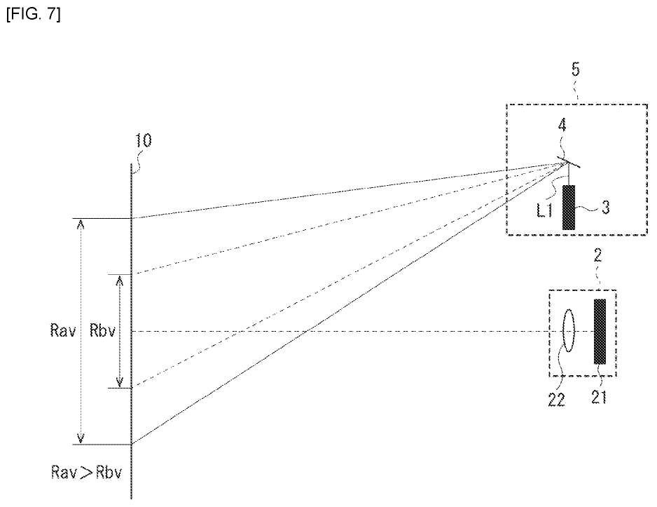

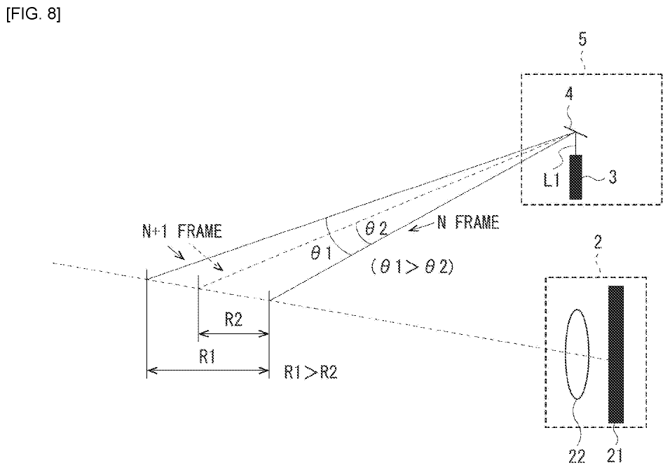

It is further configured that the scan rate by the irradiation light L1 in the irradiation unit 5 is changeable. The scan rate and the irradiation range by the irradiation light L1 and the sensing range by the sensor unit 2 are then set to attain a distance measuring mode of either a first distance measuring mode (a distance measuring accuracy improvement mode) under which the distance measuring accuracy is improved while the scan rate is kept constant or a second distance measuring mode (a scan rate increase mode) under which the scan rate is increased while the distance measuring accuracy is kept constant. Specific details will be described later with reference to FIGS. 7 and 8.

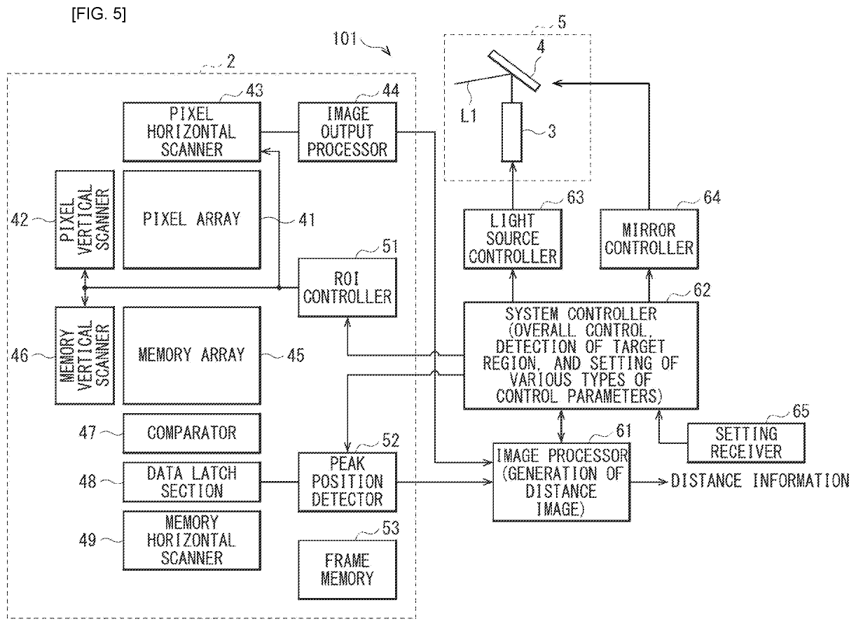

FIG. 5 schematically illustrates a configuration example of the distance measuring apparatus 101 according to the first embodiment.

The distance measuring apparatus 101 according to the first embodiment includes the sensor unit 2, the irradiation unit 5, an image processor 61, a system controller 62, a light source controller 63, a mirror controller 64, and a setting receiver 65.

The system controller 62 corresponds to a specific example of a “controller” in the technique of the present disclosure.

The sensor unit 2 includes a pixel array 41, a pixel vertical scanner 42, a pixel horizontal scanner 43, an image output processor 44, a memory array 45, a memory vertical scanner 46, a comparator 47, a data latch section 48, and a memory horizontal scanner 49. Furthermore, the sensor unit 2 includes a ROI controller 51, a peak position detector 52, and a frame memory 53.

The irradiation unit 5 includes, for example, the light source 3 such as a laser light source that emits the irradiation light L1 such as a laser beam and the scan mirror 4 such as a galvanometer mirror that changes the scan direction by the irradiation light L1. The irradiation unit 5 is configured to be able to change the scan rate by the irradiation light L1 by changing a displacement speed of the scan mirror 4.

In the pixel array 41, a plurality of pixels that detects light is disposed in a two-dimensional matrix. Signals outputted from the pixels of the pixel array 41 are transmitted, via vertical signal lines, to the memory array 45 and the pixel horizontal scanner 43.

The pixel vertical scanner 42 and the pixel horizontal scanner 43 scan inside the pixel array 41 in the vertical directions and horizontal directions, and select one of the pixels.

In a case where images are to be normally outputted, the pixels of the pixel array 41 are sequentially scanned by the pixel vertical scanner 42 and the pixel horizontal scanner 43. Signals of the pixels are outputted, via horizontal signal lines, to the image output processor 44. The signals then undergo predetermined image processing.

The memory array 45 temporarily stores the signals outputted from the pixel array 41. In a case where distance measurement is performed, a plurality of pixels lying in an identical row direction in the pixel array 41 is all simultaneously selected by the pixel vertical scanner 42. Signals from columns lying in parallel to each other are simultaneously outputted. The outputted signals are stored in the memory array 45. The memory vertical scanner 46 and the memory horizontal scanner 49 scan the memory array 45 and fetch signal data in the memory array 45. The comparator 47 performs comparison operation to acquire an inter-frame difference. The data latch section 48 latches operation data of the comparator 47, and outputs its latch data.

The peak position detector 52 detects a peak position of the inter-frame difference, as illustrated in (B) in FIG. 3, for example.

The ROI controller 51 sets the sensing range in the sensor unit 2 to a range in line with the target region Rb that is set by the system controller 62.

On the basis of a principle of triangulation using a relation between an outputted signal from the peak position detector 52 and a scan angle of the scan mirror 4, the image processor 61 generates a distance image and outputs distance information.

The system controller 62 performs overall control on the distance measuring apparatus 101. Furthermore, the system controller 62 detects the distance measuring target 1 and calculates the distance measuring target region Rb. Furthermore, the system controller 62 sets various types of control parameters for the components of the distance measuring apparatus 101.

The system controller 62 calculates the distance measuring target region Rb in line with the size of the distance measuring target 1 and sets the irradiation range of the irradiation light L1 by the irradiation unit 5 and the sensing range by the sensor unit 2 to respective ranges in line with the target region Rb. The system controller 62 sets the scan rate and the irradiation range by the irradiation light L1 and the sensing range by the sensor unit 2 to attain the distance measuring mode of either the first distance measuring mode under which the distance measuring accuracy is improved while the scan rate is kept constant or the second distance measuring mode under which the scan rate is increased while the distance measuring accuracy is kept constant. The system controller 62 sets the displacement speed of the scan mirror 4 to a speed in line with the distance measuring mode.

The light source controller 63 performs output control for the irradiation light L1 by the light source 3 on the basis of the control by the system controller 62.

The mirror controller 64 controls the scan mirror 4 on the basis of the control by the system controller 62.

The setting receiver 65 receives various types of settings provided from outside and transmits the received settings to the system controller 62. For example, settings provided from outside including the distance measuring mode are received.

### 1.2 Operation

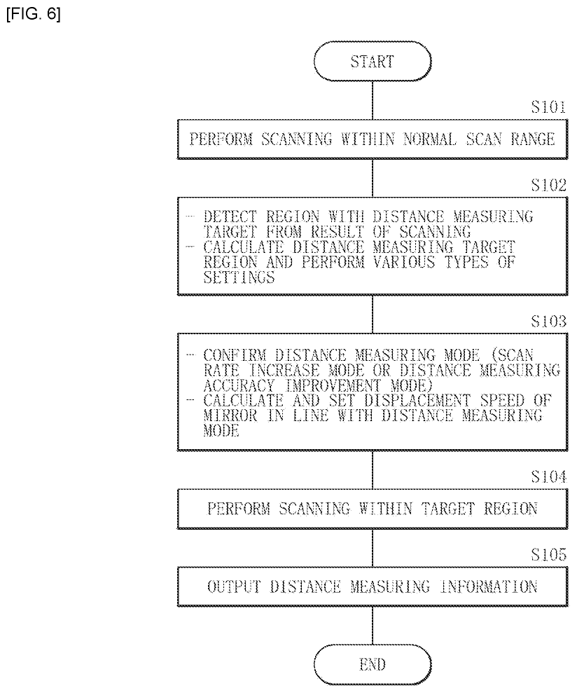

FIG. 6 is a flowchart illustrating an example of a control operation to be performed by the distance measuring apparatus 101 according to the first embodiment.

The sensor unit 2 and the irradiation unit 5 first perform scanning within the normal scan range Ra. The image processor 61 then generates a distance image (step S101). Next, the system controller 62 detects a region with the distance measuring target 1 from a result of the scanning (the generated distance image) and calculates the distance measuring target region Rb (step S102). Note that, for detecting a region with the distance measuring target 1, it is possible to detect the region with the distance measuring target 1 by preparing beforehand a reference image acquired from a result of scanning in a state where the distance measuring target 1 is not present and performing a comparison with the reference image, for example. Furthermore, the system controller 62 sets various types of settings for performing scanning within the target region Rb serving as a scan range in the ROI controller 51, the image processor 61, the light source controller 63, and the mirror controller 64. For example, various types of control parameters are set to achieve the irradiation range of the irradiation light L1 by the irradiation unit 5 and the sensing range by the sensor unit 2 in line with the target region Rb. For example, start positions and end positions of the irradiation range of the irradiation light L1 and the sensing range by the sensor unit 2 are set.

Next, the system controller 62 confirms the set distance measuring mode (the scan rate increase mode or the distance measuring accuracy improvement mode). The system controller 62 calculates the displacement speed of the mirror in line with the distance measuring mode. The system controller 62 then sets control parameters in line with the displacement speed in the mirror controller 64 (step S103).

Next, the system controller 62 causes the components to execute scanning within the target region Rb (step S104). The image processor 61 outputs distance information acquired as a result of the scanning (step S105).

FIG. 7 illustrates a principle of a control operation in a case where the scan rate is to be increased (the scan rate increase mode) in the distance measuring apparatus 101 according to the first embodiment. Under the scan rate increase mode, the scan rate is increased while the distance measuring accuracy is kept constant.

A case where the irradiation light L1 is used to perform scanning in the vertical directions will now be described below. In a case where the scan range is set to the target region Rb that is narrower than the normal scan range Ra, the scan range Rbv extending in the vertical directions in the target region Rb becomes narrower than the scan range Rav extending in the vertical directions in the normal scan range Ra. In a case where scanning is performed within the target region Rb, keeping constant the displacement speed of the scan mirror 4 to a displacement speed identical to that in a case where scanning is performed within the normal scan range Ra makes it possible to attain a shorter period of time of one scanning by the irradiation light L1 than that in a case where scanning is performed within the normal scan range Ra. That is, the scan rate increases, compared with a case where scanning is performed within the normal scan range Ra.

FIG. 8 illustrate a principle of a control operation in a case where the distance measuring accuracy is to be improved (the distance measuring accuracy improvement mode) in the distance measuring apparatus 101 according to the first embodiment. Under the distance measuring accuracy improvement mode, the distance measuring accuracy is improved while the scan rate is kept constant.

In FIG. 8, a mirror moving angle (a mirror moving angle from an N frame to an N+1 frame) of the scan mirror 4 in a case where the scan range is set to the normal scan range Ra is designated as θ1. Furthermore, a mirror moving angle in a case where a scan region is narrowed (in a case where the scan range is set to the target region Rb) is designated as θ2. An inter-frame moving range R2 of the irradiation light L1 in a case where the scan range is set to the target region Rb becomes narrower than an inter-frame moving range R1 of the irradiation light L1 in a case where scanning is performed within the normal scan range Ra. Furthermore, in a case where the scan rate is kept constant in a case where scanning is performed within the target region Rb, the displacement speed of the scan mirror 4 becomes slower than that in a case where scanning is performed within the normal scan range Ra. Furthermore, since a pixel reading region becomes narrower than that in a case where the scan range is set to the normal scan range Ra, the frame rate in the sensor unit 2 becomes faster. Since the mirror moving angle θ2 between frames becomes narrower than that in a case where the frame rate is increased, as described above, pixel reading accuracy (resolution) is improved. The distance measuring accuracy is therefore improved.

### (About Cutting-Out Range and Scan Directions for Target Region Rb)

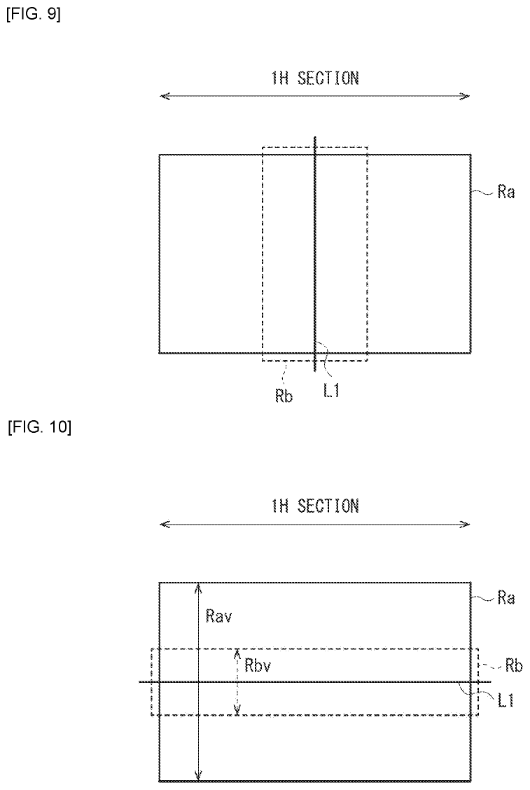

FIG. 9 illustrates a first example of a cutting-out range and scan directions for the distance measuring target region Rb. FIG. 10 illustrates a second example of the cutting-out range and the scan directions for the distance measuring target region Rb.

In a case where the target region Rb that is narrower in the horizontal directions than the normal scan range Ra is cut out, and, furthermore, the scan directions of the irradiation light L1 are set to the horizontal directions, as illustrated in FIG. 9, there are restrictions in increasing a pixel reading speed, since there are restrictions in a pixel reading time in the horizontal directions in the sensor unit 2. In a case where the target region Rb that is narrower in the vertical directions than the normal scan range Ra is cut out, and, furthermore, the scan directions of the irradiation light L1 are set to the vertical directions, as illustrated in FIG. 10, on the other hand, there are no restrictions in increasing the pixel reading speed, since there are no restrictions in the pixel reading time in the vertical directions in the sensor unit 2. It is therefore sufficient that the target region Rb be at least set to a range where the scan range Rbv extending in the vertical directions becomes narrower than the scan range Rav extending in the vertical directions in the normal scan range Ra. Furthermore, it is sufficient that the scan mirror 4 be controlled to change the scan directions by the irradiation light L1 to the vertical directions.

### 1.3 Effects

With the distance measuring apparatus 101 and the distance measuring method according to the first embodiment, as described above, the target region Rb in line with the size of the distance measuring target 1 is calculated, and the irradiation range of the irradiation light L1 and the sensing range of the irradiation light L1 are set to respective ranges in line with the target region Rb. It is therefore possible to perform distance measurement in a desired distance measuring state.

For example, setting the distance measuring mode to the distance measuring accuracy improvement mode makes it possible to improve the distance measuring accuracy for the distance measuring target 1 without decreasing the scan rate. Furthermore, setting the distance measuring mode to the scan rate increase mode makes it possible to increase the scan rate while the distance measuring accuracy is identical to a normal one.

Note that the effects described in the specification are mere examples. The effects are not limited to the effects described in the specification. There may be any other effects than those described herein. The same applies to the effects of other embodiments described below.

### 2. Second Embodiment

Next, a distance measuring apparatus and a distance measuring method according to a second embodiment of the present disclosure will now be described herein. Note that like reference numerals designate substantially identical or corresponding components in the distance measuring apparatus according to the first embodiment described above. Some descriptions are thus appropriately omitted.

### 2.0 Comparative Example

FIG. 11 illustrates an outline of a distance measuring method to be performed by a distance measuring apparatus according to a second comparative example.

A configuration of and the distance measuring method performed by the distance measuring apparatus according to the second comparative example are similar to those of the distance measuring apparatus according to the first comparative example illustrated in FIG. 1. In the distance measuring apparatus according to the second comparative example, however, the distance measuring target 1 is placed on a belt conveyor 70 and is moved.

In the distance measuring apparatus using the optical cutting method of causing a galvanometer mirror or the like to perform scanning with the irradiation light L1, for example, a shape of a distance image acquired as a result of detection by the sensor unit 2 may be deformed unless the distance measuring target 1 is stationary until the irradiation light L1 in a slit shape has been fully emitted to the scan range Ra (see the upper right side in FIG. 11). In a case of a method of removing a background by removing an inter-frame difference in identical pixels and of detecting only the irradiation light L1 in detecting the irradiation light L1 in the sensor unit 2, it is difficult to accurately perform measurement unless the distance measuring target 1 is stationary between the frames. There may therefore be difficulties for use in measuring the shape of the distance measuring target 1 placed on the belt conveyor 70, for example.

### 2.1 Configuration

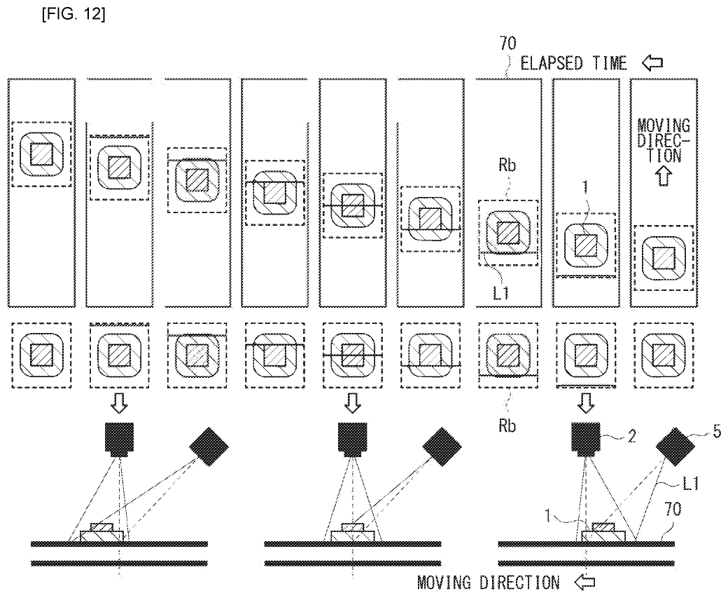

FIG. 12 illustrates an outline of a distance measuring method to be performed by a distance measuring apparatus 102 according to the second embodiment.

In the distance measuring apparatus 102 according to the second embodiment, the distance measuring target region Rb in line with the size of the distance measuring target 1 is calculated, similar to the distance measuring apparatus 101 according to the first embodiment described above. The irradiation range of the irradiation light L1 by the irradiation unit 5 and the sensing range by the sensor unit 2 are then set to respective ranges in line with the target region Rb. In the distance measuring apparatus 102 according to the second embodiment, the set position of the target region Rb is then caused to move to track movement of the distance measuring target 1. The irradiation position of the irradiation light L1 by the irradiation unit 5 is also caused to move to track the movement of the distance measuring target 1.

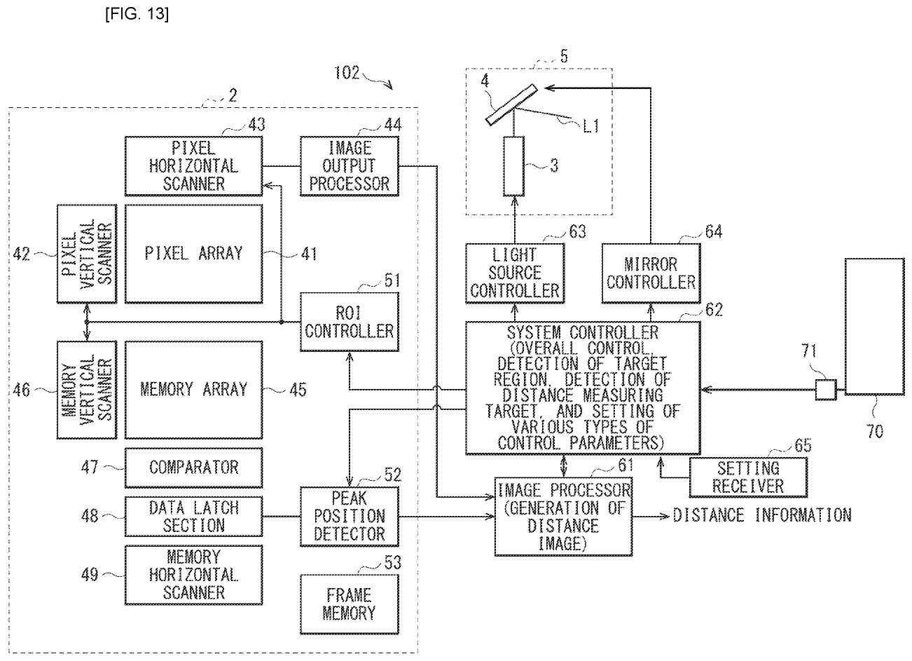

FIG. 13 schematically illustrates a configuration example of the distance measuring apparatus 102 according to the second embodiment.

The distance measuring apparatus 102 according to the second embodiment further includes a speed sensor 71 that detects a speed of the belt conveyor 70, in addition to the configuration of the distance measuring apparatus 101 according to the first embodiment described above (FIG. 5). Since the distance measuring target 1 is secured on the belt conveyor 70, the speed that the speed sensor 71 detects is substantially identical to a moving speed of the distance measuring target 1.

The speed sensor 71 corresponds to a specific example of a “detector” in the technique of the present disclosure.

The system controller 62 causes the set position of the target region Rb to move to track the movement of the distance measuring target 1 on the basis of a moving state of the distance measuring target 1, which is detected by the speed sensor 71.

The system controller 62 controls the mirror controller 64 and causes the irradiation position of the irradiation light L1 by the irradiation unit 5 to move to track the movement of the distance measuring target 1.

### 2.2 Operation

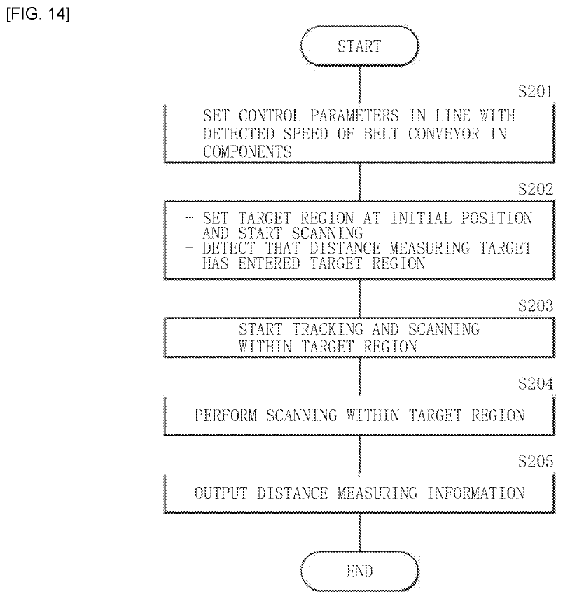

FIG. 14 is a flowchart illustrating an example of a control operation to be performed by the distance measuring apparatus 102 according to the second embodiment.

The system controller 62 first sets control parameters in line with the speed of the belt conveyor 70, which is detected by the speed sensor 71, in the components including the ROI controller 51, the image processor 61, the light source controller 63, and the mirror controller 64 (step S201). The system controller 62 sets the target region Rb at an initial position, starts scanning, and detects that the distance measuring target 1 has entered the target region Rb (step S202). At this time, the system controller 62 causes the irradiation light L1 to be emitted in a state where the scan mirror 4 is fixed. The sensor unit 2 performs imaging in this state to calculate an inter-frame difference between a pixel value of a present frame in the pixel array 41 and a pixel value of a previous frame, which is stored in the memory array 45. The memory vertical scanner 46 controls the memory array 45 in line with a set value for calculating an inter-frame difference. The system controller 62 determines whether or not the distance measuring target 1 has entered the target region Rb, from position information based on a result of the detection by the peak position detector 52. The initial state is maintained until the distance measuring target 1 enters the target region Rb.

In a case where it is detected that the distance measuring target 1 has entered the target region Rb that lies at the initial position, the system controller 62 causes the components to start tracking and scanning within the target region Rb (step S203). The image processor 61 outputs distance information acquired by performing the scanning (step S204) within the target region Rb (step S205).

### 2.3 Modification Example

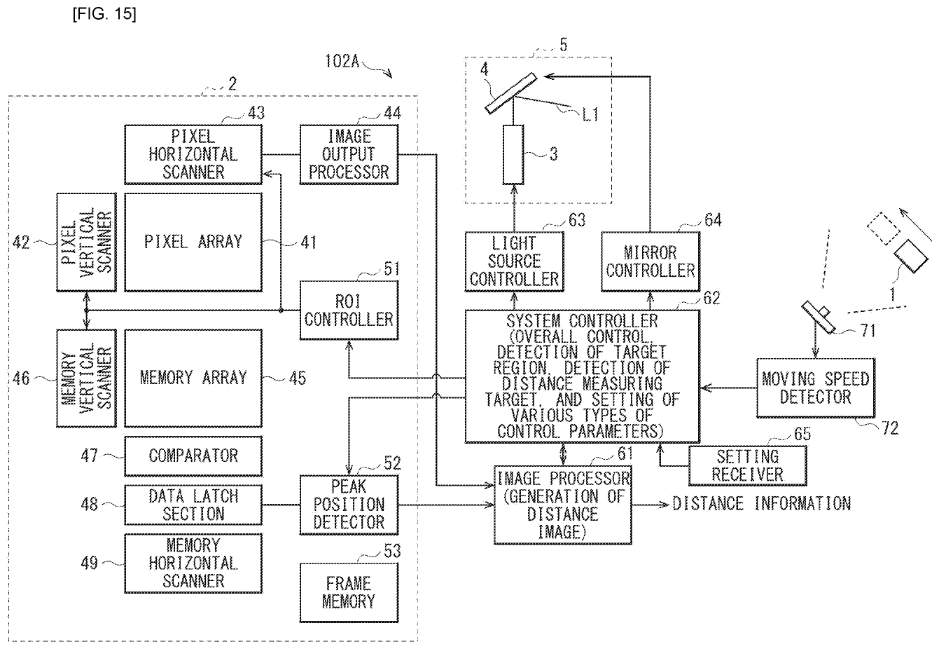

FIG. 15 schematically illustrates a configuration example of a distance measuring apparatus 102A according to a modification example of the second embodiment.

In the configuration illustrated in FIG. 13, the moving speed of the distance measuring target 1 placed on the belt conveyor 70 is detected. However, the moving speed of the distance measuring target 1 itself may be detected. The distance measuring apparatus 102A according to the modification example includes the speed sensor 71 and a moving speed detector 72 to detect the moving speed of the distance measuring target 1 itself.

The speed sensor 71 and the moving speed detector 72 correspond to a specific example of a “detector” in the technique of the present disclosure.

### 2.4 Effects

With the distance measuring apparatus 102 and the distance measuring method according to the second embodiment, as described above, the set position of the target region Rb is caused to move to track the movement of the distance measuring target 1. It is therefore possible to suppress such an event that a distance image acquired as a result of detection by the sensor unit 2 is deformed in shape.

Note that, in the distance measuring apparatus 102 according to the second embodiment, it is also possible to select the distance measuring mode of either the distance measuring accuracy improvement mode or the scan rate increase mode, similar to the distance measuring apparatus 101 according to the first embodiment described above.

Others may be substantially similar in configuration, operation, and effect to the distance measuring apparatus 101 and the distance measuring method according to the first embodiment described above.

### 3. Third Embodiment

Next, a distance measuring apparatus and a distance measuring method according to a third embodiment of the present disclosure will now be described herein. Note that like reference numerals designate substantially identical or corresponding components in the distance measuring apparatus according to the first or second embodiment described above. Some descriptions are thus appropriately omitted.

### 3.0 Comparative Example

FIG. 16 illustrates an outline of a distance measuring method to be performed by a distance measuring apparatus according to a third comparative example.

In the distance measuring apparatus 102 according to the second embodiment, a galvanometer mirror or the like is used to perform scanning with the irradiation light L1 to scan the distance measuring target 1 that is placed on the belt conveyor 70 and that is moving. Furthermore, the set position of the target region Rb is caused to move to track the movement of the distance measuring target 1. In the distance measuring apparatus according to the third comparative example, on the other hand, the distance measuring target 1 that is placed on the belt conveyor 70 and that is moving, for example, is scanned in a state where the position of the target region Rb and the irradiation position of the irradiation light L1 by the irradiation unit 5 are fixed.

In a case where, in such a distance measuring environment as described above, the sensor unit 2 performs imaging, and an inter-frame difference between a pixel value of the present frame in the pixel array 41 and a pixel value of the previous frame, which is stored in the memory array 45, is to be calculated, an inter-frame difference between locations different from each other on the distance measuring target 1 is calculated, making it difficult to perform accurate distance measurement.

### 3.1 Configuration

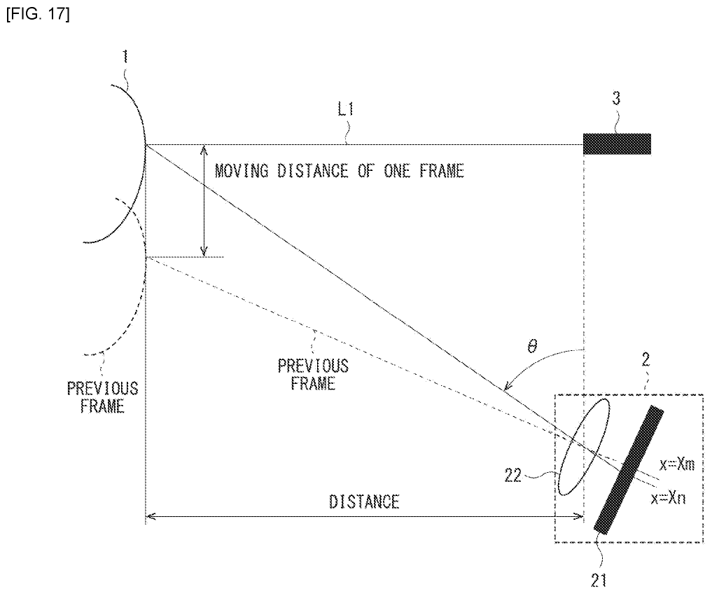

FIG. 17 illustrates a principle of the distance measuring method using trigonometry to be performed by a distance measuring apparatus 103 according to the third embodiment.

Before describing a configuration of the distance measuring apparatus 103 and the distance measuring method according to the third embodiment, the principle of the distance measuring method using trigonometry in such a distance measuring environment as described above will first be described with reference to FIG. 17.

In trigonometry, as illustrated in FIG. 17, the sensor unit 2 and the irradiation unit 5 are disposed to be away from each other with respect to the distance measuring target 1 that undergoes distance measurement. In such a disposition state as described above, the irradiation light L1 is emitted from the light source 3 to a predetermined position on the distance measuring target 1. In such a disposition state as described above, it is assumed in here that the distance measuring target 1 moves from a lower position to an upper position, for example. In this case, the sensor 21 scans the distance measuring target 1 at intervals in line with the moving speed of the distance measuring target 1 and the frame rate of the sensor 21.

Note herein that, in a case where scanning at a position where the distance measuring target 1 is present is focused on, a viewing angle (θ) of the distance measuring target 1 in a sight direction of the sensor 21 is uniquely determined at a position where reflected light by the distance measuring target 1 of the irradiation light L1 is detected (x=Xn). That is, by knowing a pixel position from which the irradiation light L1 is detected, the viewing angle of the distance measuring target 1 is determined. Therefore, a distance from the sensor 21 to the distance measuring target 1 is determined.

By performing calibration beforehand for a detection position of reflected light and the viewing angle in an actual image sensor, and storing its data as a table on a side of the distance measuring apparatus 103, however, it is possible to perform highly-accurate absolute measurement of a distance.

In detecting reflected light by the distance measuring target 1 of the irradiation light L1, it is effective that reflected light of the irradiation light L1 is detected using an inter-frame difference used to remove the influences of other ambient light than the irradiation light L1. An inter-frame difference is to be acquired for pixels at positions in line with the viewing angle that changes per one frame on the basis of a speed of the distance measuring target 1. To acquire an inter-frame difference, in the example illustrated in FIG. 17, an inter-frame difference is computed for a pixel at a position indicated as x=Xm and a pixel at a position indicated as x=Xn.

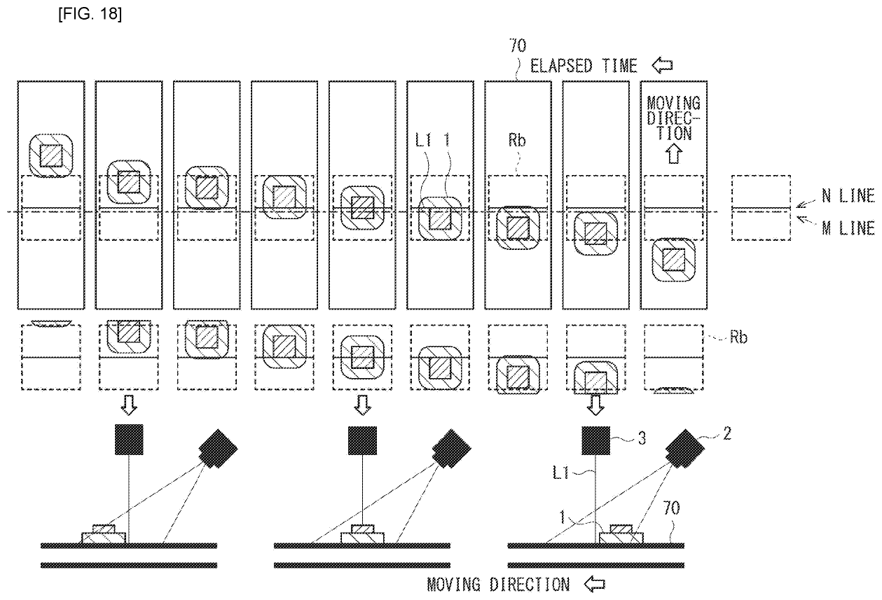

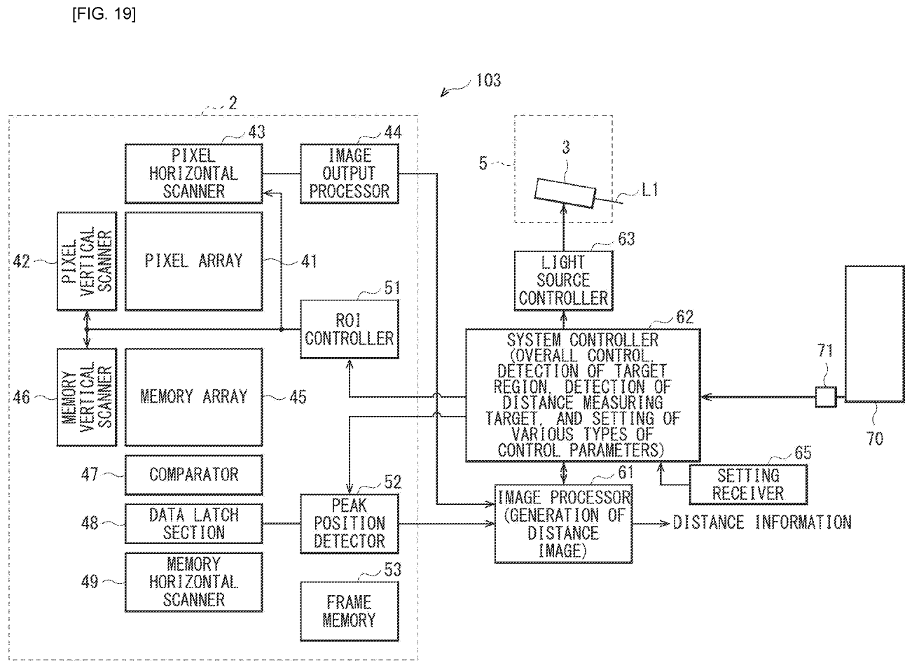

FIG. 18 illustrates an outline of the distance measuring method to be performed by the distance measuring apparatus 103 according to the third embodiment. FIG. 19 schematically illustrates a configuration example of the distance measuring apparatus 103 according to the third embodiment.

In the distance measuring apparatus 102 according to the second embodiment, a galvanometer mirror or the like is used to perform scanning with the irradiation light L1 to scan the distance measuring target 1 that is placed on the belt conveyor 70 and that is moving. Furthermore, the set position of the target region Rb is caused to move to track the movement of the distance measuring target 1. In the distance measuring apparatus 103 according to the third embodiment, on the other hand, the distance measuring target 1 that is placed on the belt conveyor 70 and that is moving, for example, is scanned in a state where the position of the target region Rb and the irradiation position of the irradiation light L1 by the irradiation unit 5 are fixed. The scan mirror 4 is not provided in the irradiation unit 5. Furthermore, the mirror controller 64 is not provided. The sensor unit 2 detects the irradiation light L1 emitted to the distance measuring target 1 that has moved and entered the target region Rb.

The distance measuring apparatus 103 according to the third embodiment includes the speed sensor 71 that detects the speed of the belt conveyor 70, similar to the distance measuring apparatus 102 according to the second embodiment.

The sensor unit 2 performs sensing within the target region Rb across a plurality of frames. The sensor unit 2 calculates a signal value acquired by removing an inter-frame difference between a pixel signal value of a first pixel line (for example, an N line) drawn by a first frame among a plurality of frames and a pixel signal value of a second pixel line (for example, an M line) drawn by a second frame that is later than the first frame, the second pixel line corresponding to the first pixel line. The sensor unit 2 outputs the calculated signal value.

The system controller 62 sets, on the basis of the moving state of the distance measuring target 1, which is detected by the speed sensor 71, line positions of the first pixel line and the second pixel line, which are used to calculate an inter-frame difference, to respective line positions in line with the moving state of the distance measuring target 1.

The system controller 62 sets the line positions of the first pixel line and the second pixel line, which are used to calculate an inter-frame difference, to respective line positions in line with an amount of movement of the distance measuring target 1 that moves for a period of time from the first frame to the second frame.

### 3.2 Operation

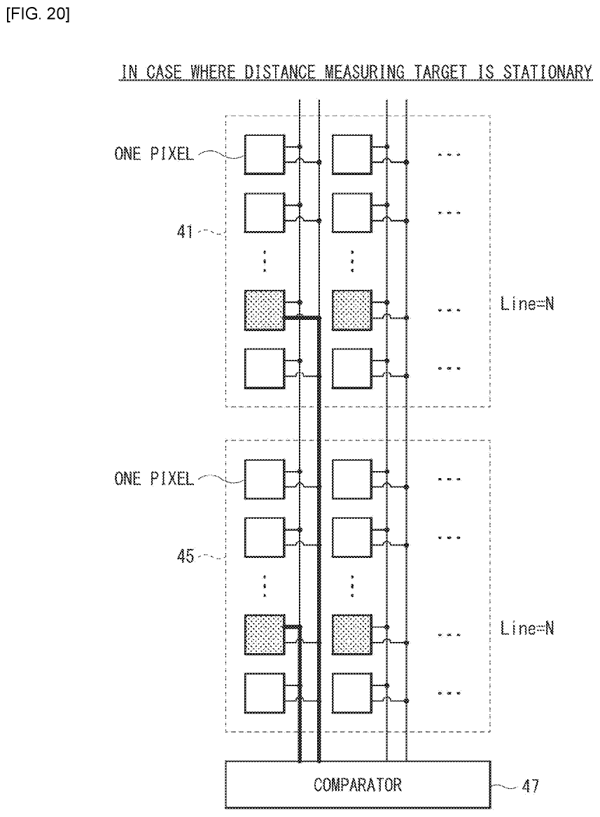

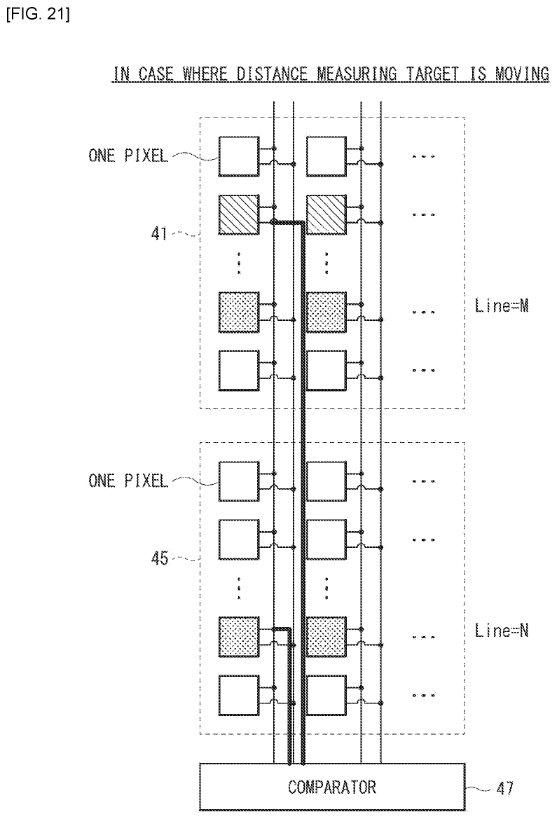

FIG. 20 schematically illustrates an example of pixel lines used to compute an inter-frame difference in a case where the distance measuring target 1 is stationary. FIG. 21 schematically illustrates an example of pixel lines used to compute an inter-frame difference in a case where the distance measuring target 1 is moving.

For an inter-frame difference, a difference between pixels that image an identical location on the distance measuring target 1 is calculated. In a case where the distance measuring target 1 is stationary (FIG. 20), pixel lines used to compute an inter-frame difference may be identical to each other (for example, the N line). In a case where the distance measuring target 1 is moving (FIG. 21), on the other hand, it is necessary to calculate a difference between pixel lines that differ from each other in line with the movement (for example, the N line and the M line).

In the distance measuring apparatus 103 according to the third embodiment, a moving distance of the distance measuring target 1 between frames is calculated beforehand to make it possible to calculate a difference between pixel lines that differ from each other. The calculated distance is set in the sensor unit 2 to calculate a difference between the pixel lines in line with the calculated distance. During calculation operation for an inter-frame difference, a value of the difference calculated between the set pixel lines is outputted from the sensor unit 2.

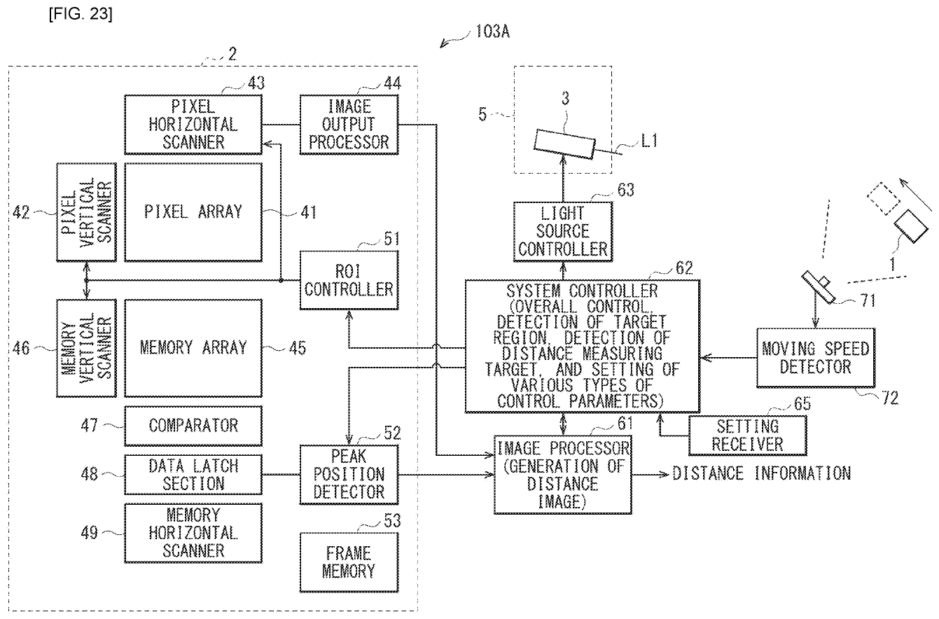

FIG. 23 is a flowchart illustrating an example of a control operation to be performed by the distance measuring apparatus 103 according to the third embodiment.

The system controller 62 first sets initial values as various types of control parameters such as a scan range (the target region Rb) in the components including the ROI controller 51, the image processor 61, and the light source controller 63 (step S301). Next, the speed sensor 71 detects a speed of the belt conveyor 70 (step S302).

Next, the system controller 62 calculates parameters for calculating such an inter-frame difference as described above as control parameters in line with the detected speed of the belt conveyor 70. The system controller 62 then sets the calculated parameters in the sensor unit 2 (step S303). Next, the image processor 61 outputs distance information acquired by performing scanning (step S304) within the target region Rb (step S305).

### 3.3 Modification Example

FIG. 23 schematically illustrates a configuration example of a distance measuring apparatus 103A according to a modification example of the third embodiment.

In the configuration illustrated in FIG. 19, the moving speed of the distance measuring target 1 placed on the belt conveyor 70 is detected. However, the moving speed of the distance measuring target 1 itself may be detected. The distance measuring apparatus 103A according to the modification example includes the speed sensor 71 and the moving speed detector 72 to detect the moving speed of the distance measuring target 1 itself.

The speed sensor 71 and the moving speed detector 72 correspond to a specific example of a “detector” in the technique of the present disclosure.

### 3.4 Effects

With the distance measuring apparatus 102 and the distance measuring method according to the third embodiment, as described above, parameters for calculating an inter-frame difference in line with the moving state of the distance measuring target 1 are calculated. The calculated parameters are set in the sensor unit 2. It is therefore possible to calculate a highly-accurate inter-frame difference for the distance measuring target 1 that is moving. It is thus possible to perform distance measurement even in a distance measuring environment where it is difficult to perform measurement using an inter-frame difference.

Others may be substantially similar in configuration, operation, and effect to the distance measuring apparatus 101 and the distance measuring method according to the first embodiment described above or the distance measuring apparatus 102 and the distance measuring method according to the second embodiment.

### 4. Other Embodiments

The technique according to the present disclosure is not limited to the embodiments described above. It is possible to modify and implement the technique according to the present disclosure in a wide variety of ways.

For example, the present technique may have the following configurations. In the present technique having configurations described below, a target region in line with a size of a distance measuring target is calculated. An irradiation range of irradiation light and a sensing range of the irradiation light are set to respective ranges in line with the target region. It is therefore possible to perform distance measurement in a desired distance measuring state.

(1) A distance measuring apparatus including:
an irradiation unit that emits irradiation light in a slit shape;
a sensor unit that detects the irradiation light irradiated to a distance measuring target;
an image processor that generates distance information pertaining to the distance measuring target based on a result of a detection by the sensor unit; and
a controller that calculates a distance measuring target region in line with a size of the distance measuring target and sets an irradiation range of the irradiation light by the irradiation unit and a sensing range by the sensor unit to respective ranges in line with the target region.

(2) The distance measuring apparatus described in (1) above, further including a detector that detects a moving state of the distance measuring target, in which
the sensor unit includes a plurality of pixels, the sensor unit performing sensing within the target region across a plurality of frames, the sensor unit calculating a signal value acquired by removing an inter-frame difference between a pixel signal value of a first pixel line drawn by a first frame among the plurality of frames and a pixel signal value of a second pixel line drawn by a second frame that is later than the first frame, the second pixel line corresponding to the first pixel line, the sensor unit outputting the calculated signal value, and
the controller sets, on the basis of a result of the detection by the detector, line positions of the first pixel line and the second pixel line used to calculate the inter-frame difference to respective line positions in line with the moving state of the distance measuring target.

(3) The distance measuring apparatus described in (2) above, in which the controller sets the line positions of the first pixel line and the second pixel line used to calculate the inter-frame difference to respective line positions in line with an amount of movement of the distance measuring target moving within a period of time from the first frame to the second frame.

(4) The distance measuring apparatus described in (2) or (3) above, in which
a position of the target region and an irradiation position of the irradiation light are fixed, and
the sensor unit detects the irradiation light irradiated to the distance measuring target that has moved and entered the target region.

(5) The distance measuring apparatus described in (1) above, further including a detector that detects a moving state of the distance measuring target,
in which the controller causes, on the basis of a result of the detection by the detector, a set position of the target region to move to track the movement of the distance measuring target.

(6) The distance measuring apparatus described in (5) above, in which the controller causes an irradiation position of the irradiation light by the irradiation unit to move to track the movement of the distance measuring target.

(7) The distance measuring apparatus described in (1) above, in which
the irradiation unit is configured to change a scan rate by the irradiation light, and
the controller sets the scan rate and the irradiation range by the irradiation light and the sensing range by the sensor unit to attain a distance measuring mode of either a first distance measuring mode under which distance measuring accuracy is improved while the scan rate is kept constant or a second distance measuring mode under which the scan rate is increased while the distance measuring accuracy is kept constant.

(8) The distance measuring apparatus described in (7) above, in which the irradiation unit includes a light source that emits the irradiation light and a scan mirror that changes a scan direction by the irradiation light, and the controller sets a displacement speed of the scan mirror to a speed in line with the distance measuring mode.

(9) The distance measuring apparatus described in (8) above, in which
the controller respectively sets, as the irradiation range of the irradiation light and the sensing range by the sensor unit, ranges causing a maximum irradiation range of the irradiation light and a maximum sensing range by the sensor unit to be narrower at least in vertical directions, and
the scan mirror changes the scan direction by the irradiation light in the vertical direction.

(10) A distance measuring method including:
emitting irradiation light in a slit shape;
detecting the irradiation light irradiated to a distance measuring target;
generating distance information pertaining to the distance measuring target based on a result of a detection of the irradiation light; and
calculating a distance measuring target region in line with a size of the distance measuring target and setting an irradiation range of the irradiation light and a sensing range of the irradiation light to respective ranges in line with the target region.

The present application claims the benefit of Japanese Priority Patent Application JP2021-97441 filed with the Japan Patent Office on Jun. 10, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A distance measuring apparatus comprising:
an irradiation unit that emits irradiation light in a slit shape;
a sensor unit that detects the irradiation light irradiated to a distance measuring target;
an image processor that generates distance information pertaining to the distance measuring target based on a result of a detection by the sensor unit; and
a controller that calculates a distance measuring target region in line with a size of the distance measuring target and sets an irradiation range of the irradiation light by the irradiation unit and a sensing range by the sensor unit to respective ranges in line with the target region.

2. The distance measuring apparatus according to claim 1, further comprising a detector that detects a moving state of the distance measuring target, wherein
the sensor unit includes a plurality of pixels, the sensor unit performing sensing within the target region across a plurality of frames, the sensor unit calculating a signal value acquired by removing an inter-frame difference between a pixel signal value of a first pixel line drawn by a first frame among the plurality of frames and a pixel signal value of a second pixel line drawn by a second frame that is later than the first frame, the second pixel line corresponding to the first pixel line, the sensor unit outputting the calculated signal value, and
the controller sets, on a basis of a result of a detection by the detector, line positions of the first pixel line and the second pixel line used to calculate the inter-frame difference to respective line positions in line with the moving state of the distance measuring target.

3. The distance measuring apparatus according to claim 2, wherein the controller sets the line positions of the first pixel line and the second pixel line used to calculate the inter-frame difference to respective line positions in line with an amount of movement of the distance measuring target moving within a period of time from the first frame to the second frame.

4. The distance measuring apparatus according to claim 2, wherein
a position of the target region and an irradiation position of the irradiation light are fixed, and
the sensor unit detects the irradiation light irradiated to the distance measuring target that has moved and entered the target region.

5. The distance measuring apparatus according to claim 1, further comprising a detector that detects a moving state of the distance measuring target, wherein
the controller causes, on a basis of a result of the detection by the detector, a set position of the target region to move to track the movement of the distance measuring target.

6. The distance measuring apparatus according to claim 5, wherein the controller causes an irradiation position of the irradiation light by the irradiation unit to move to track the movement of the distance measuring target.

7. The distance measuring apparatus according to claim 1, wherein
the irradiation unit is configured to change a scan rate by the irradiation light, and
the controller sets the scan rate and the irradiation range by the irradiation light and the sensing range by the sensor unit to attain a distance measuring mode of either a first distance measuring mode under which distance measuring accuracy is improved while the scan rate is kept constant or a second distance measuring mode under which the scan rate is increased while the distance measuring accuracy is kept constant.

8. The distance measuring apparatus according to claim 7, wherein
the irradiation unit includes a light source that emits the irradiation light and a scan mirror that changes a scan direction by the irradiation light, and
the controller sets a displacement speed of the scan mirror to a speed in line with the distance measuring mode.

9. The distance measuring apparatus according to claim 8, wherein
the controller respectively sets, as the irradiation range of the irradiation light and the sensing range by the sensor unit, ranges causing a maximum irradiation range of the irradiation light and a maximum sensing range by the sensor unit to be narrower at least in vertical directions, and
the scan mirror changes the scan direction by the irradiation light in the vertical direction.

10. A distance measuring method comprising:
emitting irradiation light in a slit shape;
detecting the irradiation light irradiated to a distance measuring target;
generating distance information pertaining to the distance measuring target based on a result of a detection of the irradiation light; and
calculating a distance measuring target region in line with a size of the distance measuring target and setting an irradiation range of the irradiation light and a sensing range of the irradiation light to respective ranges in line with the target region.
